(19) United States
(12) Patent Application Publication
(10) Pub. No.: US 2026/0317565 A1
(43) Pub. Date: Oct. 15, 2026

(54) INKJET INK

(71) Applicant: KYOCERA DOCUMENT SOLUTIONS INC., OSAKA (JP)

(72) Inventors: SAYAKA KITAGAWA, OSAKA (JP); KAZUKI TSUCHIHASHI, OSAKA (JP); KAZUMA KITAWAKI, OSAKA (JP)

(21) Appl. No.: 19/635,808

(22) Filed: Apr. 1, 2026

(30) Foreign Application Priority Data
Apr. 14, 2025 (JP) 2025-066091

(51) Int. Cl. C09D 11/326; C09D 11/38

(52) U.S. Cl. CPC C09D 11/326; C09D 11/38

(57) ABSTRACT

An inkjet ink includes: a pigment, a water-soluble organic solvent having a boiling point of 120° C. or more, trimethylolpropane, a betaine, a pigment dispersion resin, and water. A total content of the trimethylolpropane and the betaine in the inkjet ink is 10.0 mass % or more and 25.0 mass % or less. A content of the trimethylolpropane in the inkjet ink is larger than a content of the betaine.

### CROSS-REFERENCE TO RELATED PATENT APPLICATION

This application claims the benefit of Japanese Priority Patent Application JP 2025-066091 filed on Apr. 14, 2025, the entire contents of which are incorporated herein by reference.

### FIELD OF THE DISCLOSURE

The present disclosure relates to an inkjet ink.

### BACKGROUND OF THE DISCLOSURE

In inkjet recording apparatuses, the contact area between ink and the atmosphere increases near the ejection surface of the recording head in which nozzles are disposed, making the ink more likely to dry. For this reason, in the ink present near the ejection surface, the pigment is more likely to agglomerate due to the increase in concentration of the water-soluble organic solvent as the drying progresses. As a result, in inkjet recording apparatuses, nozzle clogging in the recording head is more likely to occur.

A technology of blending a moisturizing agent in an ink to suppress the drying of the ink has been known. As moisturizing agents, diethylene glycol-2-ethylhexylether, glycerin, trimethylolpropane, and the like have been known.

### SUMMARY OF THE DISCLOSURE

An inkjet ink according to an embodiment of the present disclosure includes: a pigment; a water-soluble organic solvent having a boiling point of 120° C. or more; trimethylolpropane; a betaine; a pigment dispersion resin; and water.

A total content of the trimethylolpropane and the betaine in the inkjet ink is 10.0 mass % or more and 25.0 mass % or less.

A content of the trimethylolpropane in the inkjet ink is larger than a content of the betaine.

### DETAILED DESCRIPTION OF THE EXEMPLARY EMBODIMENTS

It is difficult to blend a sufficient amount of diethylene glycol-2-ethylhexylether used as a moisturizing agent, which allows the drying of an ink to be sufficiently suppressed for a long period of time, because it is highly hydrophobic. Further, even with glycerin or trimethylolpropane used as a moisturizing agent, it is difficult to sufficiently suppress the drying of an ink present in the vicinity of the ejection surface by their moisturizing properties.

In view of the circumstances as described above, it is an object of the present disclosure to improve ejection stability of an inkjet ink.

An embodiment of the present disclosure will be described. Note that in the present disclosure, “acrylic” and “methacrylic” will be collectively referred to as “(meth)acrylic,” i.e., “(meth)acrylic” includes both “acrylic” and “methacrylic.”

### [Configuration of Inkjet Ink]

### (Schematic Configuration)

An inkjet ink according to an embodiment of the present disclosure (hereinafter, referred to simply also as an “ink”) includes a pigment a, a water-soluble organic solvent b, a moisturizing agent c, a pigment dispersion resin d, and water. The ink according to this embodiment is a water-based ink that is ejected onto a recording medium from a recording head of an inkjet recording apparatus to form an image on the recording medium.

Examples of the recording medium on which an image is formed with the ink according to this embodiment include a permeable recording medium and a non-permeable recording medium. The ink according to this embodiment is suitable for forming an image on a permeable recording medium having excellent permeability of inks. Examples of the permeable recording medium include printing paper and a medium using a fiber as a raw material (e.g., a fabric). Examples of the printing paper include plain paper, copy paper, recycled paper, thin paper, thick paper, and glossy paper.

The ink according to this embodiment includes the water-soluble organic solvent b having the boiling point of 120° C. or more and water as solvent components, and trimethylolpropane and a betaine are used in combination as the moisturizing agent c for suppressing the volatilization of these solvent components. In the ink according to this embodiment, the actions of trimethylolpropane and betaine constituting the water-soluble organic solvent b suppress the volatilization of solvent component effectively, thereby achieving favorable ejection stability. Details of each component of the ink according to this embodiment will be described below.

### (Pigment a)

In the ink according to this embodiment, for example, a yellow pigment, an orange pigment, a red pigment, a blue pigment, a purple pigment, or a black pigment can be used as the pigment a. Examples of the yellow pigment include C.I. Pigment Yellow 74, 93, 95, 109, 110, 120, 128, 138, 139, 151, 154, 155, 173, 180, 185, or 193. Examples of the orange pigment include C.I. Pigment Orange 34, 36, 43, 61, 63, or 71. Examples of the red pigment include C.I. Pigment Red 122 or 202. Examples of the blue pigment include C.I. Pigment Blue 15 or 15:3. Examples of the purple pigment include C.I. Pigment Violet 19, 23, or 33. Examples of the black pigment include C.I. Pigment Black 7. In the ink according to this embodiment, the content of the pigment a is favorably 3.0 mass % or more and 20.0 mass % or less, more favorably 7.0 mass % or more and 12.0 mass % or less.

### (Water-Soluble Organic Solvent b)

The water-soluble organic solvent b in the ink according to this embodiment is a high-boiling-point organic solvent having a boiling point of 120° C. or more. Examples of the water-soluble organic solvent b include a glycol compound, a triol compound, a glycol ether compound, a lactam compound, an acetate compound, thiodiglycol, and dimethylsulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, tetraethylene glycol, and 2-ethyl-1,2-hexanediol. As the glycol compound, ethylene glycol, diethylene glycol, 2-ethyl-1,2-hexanediol, 3-methyl-1,5-pentanediol, 1,3-propanediol, 1,5-pentanediol, or propylene glycol is favorable.

Examples of the triol compound include glycerin and 1,2,3-butanetriol.

Examples of the glycol ether compound include diethyl diglycol, diethylene glycol monobutylether, ethylene glycol monomethylether, ethylene glycol monobutylether, diethylene glycol monomethylether, diethylene glycol monoethylether, diethylene glycol diethylether (diethyl diglycol), triethylene glycol monomethylether, triethylene glycol monoethylether, triethylene glycol monobutylether, and propylene glycol monomethylether. As the glycol ether compound, triethylene glycol monobutylether is favorable.

Examples of the lactam compound include 2-pyrrolidone and N-methyl-2-pyrrolidone. As the lactam compound, 2-pyrrolidone is favorable.

Examples of the acetate compound include diethylene glycol monoethyl ether acetate.

As the water-soluble organic solvent b, a glycol compound or a glycol ether compound is favorable, and ethylene glycol or diethyl diglycol is more favorable.

In the ink according to this embodiment, the content of the water-soluble organic solvent b is favorably 10.0 mass % or more and 50.0 mass % or less, more favorably 30.0 mass % or more and 40.0 mass % or less.

### (Moisturizing Agent c)

In the ink according to this embodiment, trimethylolpropane and a betaine are used in combination as the moisturizing agent c. In the ink according to this embodiment, the trimethylolpropane has a carbon chain longer than that of glycerin commonly used as a moisturizing agent, and functions to suppress the volatilization of the high-boiling-point water-soluble organic solvent. Further, in the ink according to this embodiment, the betaine has moisturizing properties higher than those of glycerin commonly used as a moisturizing agent, and functions to suppress the volatilization of water.

For this reason, in the ink according to this embodiment, since the volatilization of both the water-soluble organic solvent b and water is suppressed, the agglomeration of the pigment a is suppressed, making it easier to maintain the state in which the pigment a is disposed in the solvent component. Therefore, in the ink according to this embodiment, favorable ejection stability can be achieved. Thus, in the ink according to this embodiment, the actions of trimethylolpropane and betaine constituting the water-soluble organic solvent b allow favorable ejection stability to be achieved.

In the ink according to this embodiment, in order to effectively achieve the effect of suppressing volatilization of the water-soluble organic solvent b and water, the total content of the trimethylolpropane and the betaine is 10.0 mass % or more and 25.0 mass % or less and the content of the trimethylolpropane is larger than the content of the betaine. Further, in the ink according to this embodiment, the content of trimethylolpropane is favorably 1.0 mass % or more and 20.0 mass % or less, and the content of the betaine is favorably 0.1 mass % or more and 5.0 mass % or less.

### (Pigment Dispersion Resin d)

The pigment dispersion resin d for enhancing the dispersibility of the pigment a in the solvent is blended in the ink according to this embodiment. The pigment dispersion resin d is fine particles of a resin and is adsorbed on the surface of the pigment a to suppress the agglomeration of the pigment a. In the ink in which the pigment dispersion resin d is blended, the pigment a and the pigment dispersion resin d integrally constitute a pigment dispersion. The pigment dispersion includes, for example, a core including the pigment a and the pigment dispersion resin d coating the core. Part of the pigment dispersion resin d may be dispersed in the solvent without being adsorbed on the surface of the pigment a.

As the pigment dispersion resin d, a known pigment dispersion resin can be appropriately selected and used. The pigment dispersion resin d may be a random polymer or a block polymer. Specific examples of the pigment dispersion resin d include polyester, polyurethane, (meth)acrylic acid, a styrene-(meth)acrylic acid copolymer, a styrene-maleic acid copolymer, a styrene-maleic acid half ester copolymer, a vinyl naphthalene-(meth)acrylic acid copolymer, and a vinyl naphthalene-maleic acid copolymer. Examples of the styrene-(meth)acrylic acid copolymer include a resin including a unit derived from styrene and a unit derived from (meth)acrylic acid, (meth)acrylic acid ester, or methacrylic acid ester. Examples of the styrene-(meth)acrylic acid copolymer include a styrene-(meth)acrylic acid-(meth)acrylic acid alkyl ester copolymer, a styrene-methacrylic acid-methacrylic acid alkyl ester-(meth)acrylic acid alkyl ester copolymer, a styrene-(meth)acrylic acid copolymer, a styrene-maleic acid-(meth)acrylic acid alkyl ester copolymer, a styrene-methacrylic acid copolymer, and a styrene-methacrylic acid alkyl ester copolymer. Of these pigment dispersion resins, a styrene-(meth)acrylic acid copolymer is favorable, a styrene-methacrylic acid-methacrylic acid alkyl ester-(meth)acrylic acid alkyl ester copolymer is more favorable, and a styrene-methacrylic acid-methyl methacrylate-butyl (meth)acrylate copolymer is still more favorable because they are easily prepared and have an excellent effect of dispersing the pigment a.

The pigment dispersion resin d favorably has a neutralization rate of 20% or more and 100% or less, more favorably 30% or more and 60% or less. Note that the neutralization rate of the pigment dispersion resin d is obtained as the percentage (100×(MB/MA)) of a usage amount MB to a theoretical value MA, MA indicating the theoretical value of the amount of the basic compound necessary for completely neutralizing the pigment dispersion resin d, MB indicating the actual usage amount of the basic compound in the dispersion step.

The pigment dispersion resin d favorably has an acid value of 50 mg KOH/g or more and 300 mg KOH/g or less, more favorably 75 mg KOH/g or more and 275 mg KOH/g or less. By setting the acid value of the pigment dispersion resin d to 50 mg KOH/g or more, the cross-linking by the cross-linking agent described below can be easily performed. By setting the acid value of the pigment dispersion resin d to 300 mg KOH/g or less, it is possible to achieve high preservation stability in the ink according to this embodiment. Note that the acid value of the pigment dispersion resin d is achieved by measurement according to JIS K 0070:1992 (Test methods for acid value, saponification value, ester value, iodine value, hydroxyl value and unsaponifiable matter of chemical products).

The mass average molecular weight (Mw) of the pigment dispersion resin d is favorably 3,000 or more and 180,000 or less, more favorably 5,000 or more and 15,000 or less. By setting the mass average molecular weight of the pigment dispersion resin d to be within this range, the efficiency of coating the surface of the pigment a is improved, and the pigment dispersion liquid and the ink are easily maintained at appropriate viscosity. The mass average molecular weight of the pigment dispersion resin d is obtained by measurement using gel permeation chromatography (“HLC-8020GPC” manufactured by TOSOH CORPORATION) in accordance with the following conditions.
Column: “TSKgel SuperMultipore HZ-H” manufactured by TOSOH CORPORATION (semi-microcolumn of 4.6 mm I.D.×15 cm)
Number of columns: 3
Eluent: tetrahydrofuran
Flow rate: 0.35 mL/min
Sample injection amount: 10 μL
Measurement temperature: 40° C.
Detector: IR detector

Note that the calibration curve is created by selecting seven types, i.e., F-40, F-20, F-4, F-1, A-5000, A-2500, and A-1000, and n-propylbenzene from TSK gel standard polystyrene manufactured by TOSOH CORPORATION.

Further, in the ink according to this embodiment, a specific resin having a cross-linked structure in which the pigment dispersion resin d is cross-linked by a cross-linking agent on the surface of the pigment a may be formed. That is, in the ink according to this embodiment, the pigment dispersion may include the pigment a and the specific resin. In the ink according to this embodiment, since the specific resin coating the pigment a has a cross-linked structure, the specific resin is bound to the surface of the pigment a, thereby preventing the specific resin from separating from the surface of the pigment a. In the ink according to this embodiment, since a strong binding force of the specific resin to the surface of the pigment a can be achieved while maintaining the effect of suppressing the agglomeration of the pigment a by the pigment dispersion resin d, the dispersed state of the pigment dispersion is easily maintained.

In the ink according to this embodiment, the specific resin favorably has a cross-linking rate of 30% or more and 90% or less, more favorably 40% or more and 70% or less. In the ink according to this embodiment, by keeping the cross-linking rate of the specific resin at 90% or less, the favorable dispersibility of the pigment dispersion is maintained, and the occurrence of nozzle clogging in the recording head can be suppressed. Further, in the ink according to this embodiment, by setting the cross-linking rate of the specific resin to 30% or more, the effect of suppressing the separation from the surface of the pigment a is favorably achieved.

The cross-linking rate refers to the percentage of the number of moles of repeating units having a cross-linked structure when the total number of moles of repeating units derived from the monomer having a functional group that reacts with the cross-linking agent in the specific resin is 100%. The cross-linking rate of the specific resin according to this embodiment is defined by an apparent cross-linking rate calculated from the equivalent number of moles of carboxy groups of the specific resin and the equivalent number of moles of cross-linked functional groups of the cross-linking agent and is calculated using the following formula.

Cross-linking rate (%)=100×(the equivalent number of moles of cross-linked functional groups of the cross-linking agent/the equivalent number of moles of carboxy groups of the specific resin)

The pigment dispersion resin d constituting the specific resin in this embodiment is favorably a styrene-(meth)acrylic acid copolymer. In the styrene-(meth)acrylic acid copolymer, the content of the styrene unit with respect to all repeating units is favorably 1.0 mass % or more and 50.0 mass % or less, more favorably 1.0 mass % or more and 30.0 mass % or less. In the styrene-(meth)acrylic acid copolymer, the content of the α-methyl styrene unit with respect to all repeating units is favorably 1.0 mass % or more and 65.0 mass % or less, more favorably 20.0 mass % or more and 65.0 mass % or less. In the styrene-(meth)acrylic acid copolymer, the content of the repeating unit derived from (meth)acrylic acid with respect to all repeating units is favorably 10.0 mass % or more and 40.0 mass % or less. In the styrene-(meth)acrylic acid copolymer, the content of the repeating unit derived from a nonionic monomer with respect to all repeating units is favorably 1.0 mass % or more and 10.0 mass % or less. The nonionic monomer is favorably at least one selected from the group consisting of polyethylene glycol (meth)acrylate (n=1 to 9) and polypropylene glycol (meth)acrylate (n=1 to 9).

The cross-linking agent used for cross-linking the pigment dispersion resin d in this embodiment is favorably a cross-linking agent having an epoxy group that reacts with the carboxy group of the pigment dispersion resin d. The epoxy group-containing cross-linking agent favorably has two or more epoxy groups, more favorably three or more epoxy groups, in its molecule. Further, the epoxy group-containing cross-linking agent favorably has a hydroxy group. The epoxy group-containing cross-linking agent is favorably water-soluble, and favorably has water solubility of 80% or more (water solubility is calculated as the mass of the dissolved epoxy compound when 10 g of the epoxy compound is mixed with 90 g of water), more favorably 100%.

Examples of the cross-linking agent that can be used for cross-linking the pigment dispersion resin d in the ink according to this embodiment include sorbitol polyglycidylether, glycerol polyglycidylether, diglycerol polyglycidylether, and polyglycerol polyglycidylether. Further, examples of the product of the cross-linking agent that can be used for cross-linking the pigment dispersion resin d in the ink according to this embodiment include DENACOL (registered trademark) EX-614B, DENACOL (registered trademark) EX-313, DENACOL (registered trademark) EX-421, DENACOL (registered trademark) EX-512, and DENACOL (registered trademark) EX-521, which are cross-linking agents manufactured by Nagase ChemteX Corporation.

In the ink according to this embodiment, the epoxy equivalent (g/eq.) of the cross-linking agent used to cross-link the pigment dispersion resin d is favorably 100 or more and 10,000 or less, more favorably 120 or more and 250 or less, from the viewpoint of causing the cross-linking agent to react with the carboxy group of the pigment dispersion resin d efficiently to enhance the dispersion stability of the pigment dispersion. When the amount of epoxy groups in the cross-linking agent is too large, the cross-linking does not efficiently progress, and the epoxy groups act as water-soluble groups instead in some cases. Further, when the amount of epoxy groups in the cross-linking agent is too small, the cross-linking points are insufficient, resulting in insufficient suppression of the separation of the specific resin from the surface of the pigment a. The mass average molecular weight of the epoxy group-containing cross-linking agent is favorably 100 or more and 1,500 or less from the viewpoints of ease of reaction and preservation stability of the aqueous pigment dispersion.

In the ink according to this embodiment, the content of the pigment dispersion is favorably 5.0 mass % or more and 30.0 mass % or less, more favorably 8.0 mass % or more and 15.0 mass % or less. In the ink according to this embodiment, by setting the content of the pigment dispersion to 5.0 mass % or more, an image with favorable image density can be easily formed on a recording medium. Further, in the ink according to this embodiment, by keeping the content of the pigment dispersion at 30.0 mass % or less, sufficient fluidity as an ink is easily achieved.

In the ink according to this embodiment, the content of the specific resin is favorably 0.5 mass % or more and 10.0 mass % or less, more favorably 2.0 mass % or more and 4.0 mass % or less. In the pigment dispersion, the content of the specific resin is favorably 10.0 mass % or more and 50.0 mass % or less, more favorably 20.0 mass % or more and 30.0 mass % or less. Further, in the pigment dispersion, the total content of the pigment a and the specific resin is favorably 90.0 mass % or more, more favorably 100 mass %. In the ink according to this embodiment, the pigment dispersion including the specific resin favorably has a volume median diameter of 30 nm or more and 200 nm or less, more favorably 80 nm or more and 140 nm or less, from the viewpoint of optimizing color density, hue, or stability.

### (Water)

In the ink according to this embodiment, ion exchanged water, purified water, distilled water, or the like can be used as water. In the ink according to this embodiment, the content of water is favorably 25.0 mass % or more and 80.0 mass % or less, more favorably 35.0 mass % or more and 60.0 mass % or less, from the viewpoints of dryness and ejection reliability.

### (Other Components)

In the ink according to this embodiment, components other than the above may be blended as necessary. As an example, a surfactant may be blended in the ink according to this embodiment. The surfactant is capable of optimizing the permeability (wettability) of the ink according to the present disclosure on a recording medium. Examples of the surfactant that can be used in the ink according to this embodiment include an anionic surfactant, a cationic surfactant, and a nonionic surfactant. As the surfactant, a nonionic surfactant is favorable. Examples of the nonionic surfactant include polyoxyethylene dodecylether, polyoxyethylene hexadecylether, polyoxyethylene nonylphenylether, polyoxyethylene sorbitan monooleate ether, monodecanoyl sucrose, and an ethylene oxide adduct of acetylene glycol. As the nonionic surfactant, an ethylene oxide adduct of acetylene glycol is favorable.

Further, in addition to the surfactant, various additives such as a dissolution stabilizer, an antioxidant, a viscosity adjustor, a pH adjuster, and an antifungal agent may be blended as necessary in the ink according to this embodiment.

### [Method of Producing Inkjet Ink]

### (Introduction)

An example of the method of producing the ink according to this embodiment will be described. An example in which the pigment dispersion resin d constitutes a specific resin having a cross-linked structure will be described below. The method of producing the ink according to this embodiment includes a dispersion step, a cross-linking step, a centrifuging step, and an ink preparation step. Note that in the method of producing the ink according to this embodiment, the centrifuging step may be omitted. Each step of the method of producing the ink according to this embodiment will be described below.

### (Dispersion Step)

In the dispersion step, dispersion treatment in which the pigment a and the pigment dispersion resin d are dispersed in water is performed to prepare a pigment dispersion liquid prior to cross-linking the pigment dispersion resin d (in this example, referred to as an “intermediate pigment dispersion liquid” in order to distinguish it from the pigment dispersion liquid after cross-linking). In the intermediate pigment dispersion liquid, a pigment dispersion that includes the pigment a and the pigment dispersion resin d adsorbed on the surface of the pigment a is dispersed in water. Examples of the dispersing apparatus to be used for dispersion include a wet dispersing apparatus such as a media disperser. The pigment dispersion resin d used in the dispersion step is favorably subjected to neutralization treatment with a basic compound (e.g., KOH or NaOH) in advance such that a predetermined neutralization rate is achieved.

In the intermediate pigment dispersion liquid, the content of the pigment dispersion resin d is favorably 4.0 mass % or more and 25.0 mass % or less. Further, in the intermediate pigment dispersion liquid, the content of the pigment a is favorably 1.0 mass % or more and 30.0 mass % or less. In the dispersion step, an antifoaming agent may be blended in the intermediate pigment dispersion liquid. In the intermediate pigment dispersion liquid, the content of the antifoaming agent is favorably 0.01 mass % or more and 0.1 mass % or less.

In the dispersion step, it is favorable to remove coarse particles by filtering the intermediate pigment dispersion liquid using a filter (e.g., a pore size of 5 μm).

### (Cross-Linking Step)

In the cross-linking step, an epoxy group-containing cross-linking agent is added to the intermediate pigment dispersion liquid obtained by the dispersion step. This causes the carboxy group of the pigment dispersion resin d adsorbed on the surface of the pigment a and the epoxy group of the cross-linking agent to react with each other, and cross-links the pigment dispersion resin d on the surface of the pigment a, thereby obtaining the pigment dispersion liquid according to this embodiment. In the cross-linking step, it is favorable to stir, after adding a cross-linking agent to the intermediate pigment dispersion liquid, the intermediate pigment dispersion liquid while heating. The heating temperature can be, for example, 50° C. or more and 95° C. or less. The heating time can be, for example, 30 minutes or more and 8 hours or less.

### (Centrifuging Step)

In the centrifuging step, centrifugal treatment is applied to the pigment dispersion liquid obtained by the cross-linking step, and the supernatant liquid of the pigment dispersion liquid after centrifugal treatment is replaced with water. As a result, in the centrifuging step, the components that have been free in water in the pigment dispersion liquid can be removed. The centrifugal treatment conditions in the centrifuging step can be, for example, a rotational speed of 10,000 rpm or more and 100,000 rpm or less and a centrifugal treatment time of 12 hours or more and 48 hours or less.

### (Ink Preparation Step)

In the ink preparation step, the water-soluble organic solvent b, the moisturizing agent c, and water are added to the pigment dispersion liquid obtained by the centrifuging step. In this way, the ink according to this embodiment is obtained. Note that in the ink preparation step, a component (more specifically, at least one of a surfactant, a dissolution stabilizer, a penetrating agent, a viscosity adjustor, or the like) other than the water-soluble organic solvent b, the moisturizing agent c, and water may be further added as necessary. In the ink preparation step, it is favorable to stir the obtained ink with a stirrer. Further, in the ink preparation step, foreign substances and coarse particles may be removed from the obtained ink using a filter (e.g., a filter having a pore size of 5 μm or less).

### EXAMPLES AND COMPARATIVE EXAMPLES

As Examples and Comparative Examples of the present disclosure, inks were prepared and evaluated. Note that the following Examples are merely examples of the present disclosure, and the configuration of the present disclosure is not limited to those in Examples.

### Preparation of Ink According to Example 1

### Synthesis of Pigment Dispersion Resin d

First, a styrene-acrylic acid copolymer was synthesized as the pigment dispersion resin d. 100.0 g of isopropyl alcohol and 250.0 g of methyl ethyl ketone were added to a four-necked flask (capacity: 1000 mL) equipped with a stirrer, a nitrogen introduction tube, a condenser, and a dropping funnel. A mixed solution was supplied to the dropping funnel. The mixed solution included 20.0 g of styrene, 40.0 g of α-methylstyrene, 5.0 g of ethylene glycol acrylate, 25.0 g of methacrylic acid, and 0.3 g of azobisisobutyronitrile (AIBN, a polymerization initiator).

Nitrogen was introduced into the flask and heated to reflux at 70° C. While being heated to reflux at 70° C., the above-mentioned mixed solution was supplied to the flask from the dropping funnel over approximately 2 hours. After the mixed solution was supplied, the mixture was heated to reflux at 70° C. for 6 hours. After that, a methyl ethyl ketone solution was supplied to the flask from the dropping funnel over 15 minutes. The methyl ethyl ketone solution included 150.0 g of methyl ethyl ketone and 0.1 g of AIBN. After the methyl ethyl ketone solution was supplied, the mixture was heated to reflux at 70° C. for 5 hours. Next, the content of the reaction vessel was subjected to reduction of pressure to remove the solvent. In this way, a styrene-acrylic acid copolymer was obtained.

### Dispersion Treatment

Next, an intermediate pigment dispersion liquid prior to cross-linking a styrene-acrylic acid dispersion resin was prepared. The styrene-acrylic acid dispersion resin was neutralized with potassium hydroxide in advance and used as an aqueous solution having a neutralization rate of 60% and a solid content of 30%, 18.0 parts by mass of carbon black (“Printex (registered trademark) 80” manufactured by Orion Engineered Carbons S.A.) as the pigment a, 7.4 parts by mass (in terms of solid content) of a styrene-acrylic acid dispersion resin, 0.1 parts by mass of an antifoaming agent (“SN-DEFOAMER 1340” manufactured by SAN NOPCO LIMITED), and ion exchanged water were mixed to obtain 100 parts by mass of a mixture.

The obtained mixture was subjected to dispersion treatment for 4 hours using a bead mill (“DYNO (registered trademark)-MILL” manufactured by Willy A Bachofen AG) to obtain an intermediate pigment dispersion liquid. In the dispersion treatment, zirconia beads (diameter of 0.5 mm) were used as media. Further, in the dispersion treatment, the filling rate of the media in the vessel of the bead mill was 60% by volume. Further, in the dispersion treatment, the treatment temperature (chiller temperature) was set to 10° C. After the dispersion treatment, the media were removed, and then, the obtained intermediate pigment dispersion liquid was filtered using a filter having a pore size of 5 μm to remove foreign substances and coarse particles.

### Cross-Linking Treatment

A 1 L three-necked flask equipped with a thermometer and a stirring blade was used as a reaction vessel, and 100 g of a pigment dispersion liquid was added to the reaction vessel. Next, while maintaining the temperature inside the reaction vessel at 30° C. using a water bath, the cross-linking agent was added to the reaction vessel and sufficiently stirred. Next, the content of the reaction vessel was stirred for 1 hour at a speed of 150 rpm. “DENACOL (registered trademark) EX-313” manufactured by Nagase ChemteX Corporation was used as the cross-linking agent, and the added amount of the cross-linking agent was 0.98 g. Next, the temperature inside the reaction vessel was raised at a heating rate of 0.5° C./min to 80° C. while stirring at 250 rpm. The content of the reaction vessel was stirred at 250 rpm for 4 hours while maintaining the temperature inside the reaction vessel at 80° C. Then, the temperature inside the reaction vessel was cooled until reaching room temperature, thereby obtaining a pigment dispersion liquid.

### Centrifugal Treatment

The obtained pigment dispersion liquid was transferred to a predetermined container, and the container was placed in a centrifugal adhesion measurement apparatus (“NS-C100” manufactured by Nano Seeds Corporation). The pigment dispersion liquid in the container was subjected to centrifugal treatment at a rotational speed of 50,000 rpm for 24 hours. After the supernatant liquid was removed from the container, ion exchanged water having the same volume as that of the removed supernatant liquid was added to the container (substitution treatment). In this way, the components that had been free in water were removed from the pigment dispersion liquid.

### Preparation of Ink

60.0 mass % of a pigment dispersion liquid, 18.0 mass % of triethylene glycol monobutyl ether (BTG), 10.0 mass % of 3-methyl-1,5-pentanediol (MPD), 9.0 mass % of 1,3-propanediol (1,3PDO), 11.0 mass % of trimethylolpropane (TMP), 4.0 mass % of a betaine, 0.3 mass % of a nonionic surfactant (“OLFINE E1004” manufactured by Nissin Chemical Co., Ltd.), and ion exchanged water (remaining amount) were stirred at a rotational speed of 400 rpm using a stirrer (“Three-One Motor BL-600” manufactured by Shinto Scientific Co., Ltd.), and then filtered using a filter (pore size: 5 μm) to obtain an ink according to Example 1.

### (Evaluation of Ink)

For the inks according to Examples and Comparative Examples, nozzle clogging was evaluated as evaluation of ejection stability. In the evaluation of nozzle clogging, A4-size inkjet matte paper (“Super Fine Paper” manufactured by Seiko Epson Corp.) was used as evaluation paper. An image forming apparatus (a line head-mounted inkjet recording apparatus, a tester manufactured by KYOCERA Document Solutions Inc.) was used as an evaluation device. A 150 mm×200 mm solid image was continuously printed on 100 sheets of evaluation paper by the evaluation device.

Next, the ink was purged from the recording head of the evaluation device, and then cleaning treatment was applied to the recording head by wiping the ejection surface of the recording head of the evaluation device. After that, a nozzle check pattern image was formed on evaluation paper using the evaluation device, and it was confirmed that ink was ejected from all nozzles. The cleaning treatment was applied to the recording head again, and then, the evaluation device was allowed to stand for 7 days with the recording head uncapped.

Next, the cleaning treatment was applied to the recording head again, and then, a nozzle check pattern image was formed on evaluation paper using the evaluation device. This nozzle check pattern image was checked, and the ratio of the number of non-ejection nozzles to all nozzles (7968) was calculated. The calculated ratio of the number of non-ejection nozzles was used as an evaluation value for nozzle clogging.

Using the evaluation value, evaluation was performed in accordance with the following criteria A and B. Inks with the evaluation of A for nozzle clogging are evaluated to “Pass,” and inks with the evaluation of B are evaluated to “Fail.”
A: less than 10%
B: 10% or more

### Examples 1 to 6

Table 1 shows the composition of the pigment a, the water-soluble organic solvent b, the moisturizing agent c, and the nonionic surfactant in each of the inks according to Examples 1 to 6. Note that the units of the numerical values shown in Table 1 are “mass %.” In Examples 2 to 6, inks were prepared in the same manner as that for the method of preparing the ink according to Example 1 such that the composition of the pigment a, the water-soluble organic solvent b, the moisturizing agent c, and the nonionic surfactant shown in Table 1 was achieved.

TABLE 1

| | | Example | | | | | |
|---|---|---|---|---|---|---|---|
| | | 1 | 2 | 3 | 4 | 5 | 6 |
| Pigment a | Printex80 | 9.0 | | | | 9.0 | 9.0 |
| | ECB-301 | | 4.5 | | | | |
| | RGT | | | 7.5 | | | |
| | 5GX01 | | | | 6.0 | | |
| Water-soluble | BTG | 18.0 | 15.0 | 15.0 | 18.0 | 10.0 | 10.0 |
| organic | MPD | 10.0 | 15.0 | 15.0 | 10.0 | 10.0 | 10.0 |
| solvent b | 1,3PDO | 9.0 | | | 9.0 | 8.0 | 8.0 |
| | 1,5PD | | 9.0 | 9.0 | | 8.0 | 8.0 |
| Moisturizing | TMP | 11.0 | 18.0 | 8.0 | 7.0 | 9.0 | 15.0 |
| agent c | Betaine | 4.0 | 0.5 | 6.0 | 3.0 | 5.0 | 6.0 |

| | | | | | | |
|---|---|---|---|---|---|---|
| Nonionic surfactant | 0.3 | 0.3 | 0.3 | 0.3 | 0.3 | 0.3 |

In Example 2, phthalocyanine blue (“ECB-301” manufactured by Dainichiseika Color & Chemicals Mfg. Co., Ltd.) was used as the pigment a. In Example 3, quinacridone magenta (“FASTROGEN (registered trademark) Super Magenta RGT” manufactured by DIC CORPORATION) was used as the pigment a. In Example 4, monoazo yellow (“Hansa (registered trademark) Brilliant Yellow 5GX01” manufactured by Clariant) was used as the pigment a. In each of Examples 5 and 6, carbon black (“Printex (registered trademark) 80” manufactured by Orion Engineered Carbons S.A.) was used as the pigment a.

In each of Examples 2 and 3, triethylene glycol monobutyl ether (BTG), 3-methyl-1,5-pentanediol (MPD), and 1,5-pentanediol (1,5PD) were used as the water-soluble organic solvent b. In Example 4, triethylene glycol monobutyl ether (BTG), 3-methyl-1,5-pentanediol (MPD), and 1,3-propanediol (1,3PDO) were used as the water-soluble organic solvent b. In each of Examples 5 and 6, triethylene glycol monobutyl ether (BTG), 3-methyl-1,5-pentanediol (MPD), 1,3-propanediol (1,3PDO), and 1,5-pentanediol (1,5PD) were used as the water-soluble organic solvent b.

In each of Examples 2 to 6, trimethylolpropane (TMP) and a betaine were used in combination as the moisturizing agent c. In the inks according to the inks according to Examples 1 to 6, the content of trimethylolpropane (TMP) and the betaine was varied.

For the inks according to Examples 1 to 6, the nozzle clogging was evaluated. Table 2 shows the evaluation results of nozzle clogging for the inks according to Examples 1 to 6. In all of the inks according to Examples 1 to 6, the nozzle clogging was evaluated to “Pass.”

TABLE 2

Nozzle clogging

| | | Evaluation | |
|---|---|---|---|
| | | value | Evaluation |
| Example | 1 | 2% | A |
| | 2 | 7% | A |
| | 3 | 4% | A |
| | 4 | 6% | A |
| | 5 | 3% | A |
| | 6 | 7% | A |

### Comparative Examples 1 to 7

Table 3 shows the composition of the pigment a, the water-soluble organic solvent b, the moisturizing agent c, and the nonionic surfactant in the inks according to Comparative Examples 1 to 7. Note that the units of the numerical values shown in Table 3 are “mass %.” In Comparative Examples 1 to 7, inks were prepared in the same manner as that for the method of preparing the ink according to Example 1 such that the composition of the pigment a, the water-soluble organic solvent b, the moisturizing agent c, and the nonionic surfactant shown in Table 3 was achieved.

TABLE 3

| | | Comparative Example | | | | | | |
|---|---|---|---|---|---|---|---|---|
| | | 1 | 2 | 3 | 4 | 5 | 6 | 7 |
| Pigment a | Printex80 | | | 9.0 | | | 9.0 | |
| | ECB-301 | 4.5 | | | | | | |
| | RGT | | | | 7.5 | 7.5 | | |
| | 5GX01 | | 6.0 | | | | | 6.0 |
| Water-soluble | BTG | 18.0 | 18.0 | 15.0 | 15.0 | 18.0 | 15.0 | 18.0 |
| organic | MPD | 10.0 | 10.0 | 15.0 | 15.0 | 10.0 | 15.0 | 10.0 |
| solvent b | 1,3PDO | 9.0 | 9.0 | | | 9.0 | | 9.0 |
| | 1,5PD | | | 9.0 | 9.0 | | 9.0 | |
| Moisturizing | TMP | | 15.0 | | 3.0 | 6.0 | 20.0 | 6.0 |
| agent c | Betaine | | | 12.0 | 10.0 | 13.0 | 6.0 | 2.0 |

| | | | | | | | |
|---|---|---|---|---|---|---|---|
| Nonionic surfactant | 0.3 | 0.3 | 0.3 | 0.3 | 0.3 | 0.3 | 0.3 |

In Comparative Example 1, phthalocyanine blue (“ECB-301” manufactured by Dainichiseika Color & Chemicals Mfg. Co., Ltd.) was used as the pigment a. In Comparative Examples 2 and 7, monoazo yellow (“Hansa (registered trademark) Brilliant Yellow 5GX01” manufactured by Clariant) was used as the pigment a. In Comparative Examples 3 and 6, carbon black (“Printex (registered trademark) 80” manufactured by Orion Engineered Carbons S.A.) was used as the pigment a. In Comparative Examples 4 and 5, quinacridone magenta (“FASTROGEN (registered trademark) Super Magenta RGT” manufactured by DIC CORPORATION) was used as the pigment a.

In each of Comparative Examples 1, 2, 5, and 7, triethylene glycol monobutyl ether (BTG), 3-methyl-1,5-pentanediol (MPD), and 1,3-propanediol (1,3PDO) were used as the water-soluble organic solvent b. In each of Comparative Examples 3, 4, and 6, triethylene glycol monobutyl ether (BTG), 3-methyl-1,5-pentanediol (MPD), and 1,5-pentanediol (1,5PD) were used as the water-soluble organic solvent b.

The inks according to Comparative Examples 1 to 7 are different from the ink according to above Example in the composition of the moisturizing agent c. Specifically, the ink according to Comparative Example 1 is different from the ink according to the above Example in that neither trimethylolpropane (TMP) nor a betaine is included as the moisturizing agent c. The ink according to Comparative Example 2 is different from the ink according to the above Example in that no betaine is included as the moisturizing agent c. The ink according to Comparative Example 3 is different from the ink according to the above Example in that no trimethylolpropane (TMP) is included as the moisturizing agent c. The inks according to Comparative Examples 4 and 5 are different from the ink according to the above Example in that the content of trimethylolpropane (TMP) is less than the content of the betaine. The ink according to Comparative Example 6 is different from the ink according to the above Example in that the total content of trimethylolpropane (TMP) and the betaine exceeds 25.0 mass %. The ink according to Comparative Example 7 is different from the ink according to the above Example in that the total content of trimethylolpropane (TMP) and the betaine is less than 10.0 mass %.

For the inks according to Comparative Examples 1 to 7, the nozzle clogging was evaluated. Table 4 shows the evaluation results of nozzle clogging for the inks according to Comparative Examples 1 to 7. In all of the inks according to Comparative Examples 1 to 7, the nozzle clogging was evaluated to “Fail.”

TABLE 4

Nozzle clogging

| | | Evaluation | |
|---|---|---|---|
| | | value | Evaluation |
| Comparative | 1 | 13% | B |
| Example | 2 | 19% | B |
| | 3 | 18% | B |
| | 4 | 14% | B |
| | 5 | 13% | B |
| | 6 | 12% | B |
| | 7 | 16% | B |

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
a pigment;
a water-soluble organic solvent having a boiling point of 120° C. or more;
trimethylolpropane;
a betaine;
a pigment dispersion resin; and
water,
a total content of the trimethylolpropane and the betaine being 10.0 mass % or more and 25.0 mass % or less,
a content of the trimethylolpropane being larger than a content of the betaine.

2. The inkjet ink according to claim 1, wherein
the water-soluble organic solvent includes at least one of triethylene glycol monobutyl ether, 3-methyl-1,5-pentanediol, 1,3-propanediol, or 1,5-pentanediol.

3. The inkjet ink according to claim 1, wherein
the pigment dispersion resin is cross-linked on a surface of the pigment.
